(19) United States
(12) Patent Application Publication
(10) Pub. No.: US 2012/0290833 A1
(43) Pub. Date: Nov. 15, 2012

(54) Certificate Blobs for Single Sign On

(75) Inventors: David Lyndon Clegg, Altadena, CA (US); Bradley Edward Schmidt, Eagle, ID (US); Evan Ireland, Wellington (NZ)

(73) Assignee: Sybase, Inc., Dublin, CA (US)

(21) Appl. No.: 13/171,985

(22) Filed: Jun. 29, 2011

Related U.S. Application Data
(60) Provisional application No. 61/485,302, filed on May 12, 2011.

(51) Int. Cl. H04L 9/14

(52) U.S. Cl. 713/156

(57) ABSTRACT

A system, method and a computer-readable medium for generating an authentication password for authenticating a client to a server. A digital certificate that includes private key, and a public key is provided. A hash of a content of a digital certificate is generated. The hash is also encrypted with a private key. The encrypted hash and the content of the digital certificate are encoded into a certificate blob, which is utilized as an authorization password.

This application claims the benefit of U.S. Provisional Application No. 61/485,302, filed May 12, 2011 which is herein incorporated by reference in its entirety.

### BACKGROUND OF THE INVENTION

1. Field of the Invention

The present invention is generally related to authentication, and more particularly related to authentication using private and public keys.

2. Background Art

Sending, receiving and retrieving data over a public network, such as the Internet or the World Wide Web (“the Web”) generates a need for controlling access to the data. For example, only authorized computing devices may access data stored on many servers accessible using the Web. One way to authenticate computing devices is by using cryptography and public key infrastructure (PKI) authentication. A conventional PKI authentication includes a digital certificate, and public and private keys that make up a public-private key pair. A public key is generally known to the world, whereas the private key is secret and is only known by a computing device that requires authentication. Conventionally, a digital certificate is signed with a private key by a computing device that requests access to data and is authenticated by an authentication server that stores the corresponding public key.

However, in a conventional secure socket layer (SSL) authentication, a server does not store the public keys associated with a client. Instead, the conventional server receives digital certificate of a client that includes a public key. Upon receipt, the conventional server sends a randomly generated sequence of bytes (also known as a “nonce”) back to the client. The client encrypts the “nonce” with its private key and returns the encrypted nonce back to the server, where the nonce is decrypted using the public key. The conventional server then compares the nonce that it sent to the client with the nonce that was decrypted with the public key to determine a match.

However, this type of an authentication may not work when a server cannot exchange multiple messages with a client. For example, when a server is a relay server or a proxy server, the server may not establish back and forth communication with the client. Thus, what is need are systems and methods where a server may authenticate the client upon a receipt of a digital certificate.

### BRIEF SUMMARY OF THE INVENTION

The present invention is directed to systems, methods and computer program products for generating an authentication password for authenticating a client to a server. A digital certificate that includes a private key and a public key are provided. A hash of a content of a digital certificate is generated. The hash is also encrypted with a private key. The encrypted hash and the content of the digital certificate are encoded into a certificate blob, which is utilized as an authentication password.

The present invention is also directed to systems, methods and computer program products for authenticating a certification blob of a client. A certificate blob is received by the server. A decoder decodes the binary encoding of the certificate blob into an encrypted hash, generated using a private key, and a content of a digital certificate. A public key is extracted from the content of the digital certificate. The content of the digital certificate is hashed into a hash. The encrypted hash is decrypted using the public key. A PKI verification module compares the hashes and determines whether the hashes where generated by a public-private key pair. If the hashes were generated by the pubic-private key pair, access to the client is granted.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a distributed system, according to an embodiment.

FIG. 2 is a block diagram of a certificate authentication system, according to an embodiment.

FIG. 3 is a flowchart of a method for creating a certificate blob on a client, according to an embodiment.

FIG. 4 is a flowchart of a method for authenticating the certificate blob on a server, according to an embodiment.

FIG. 5 illustrates an example computer useful for implementing components of the invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION OF THE INVENTION

### 1. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

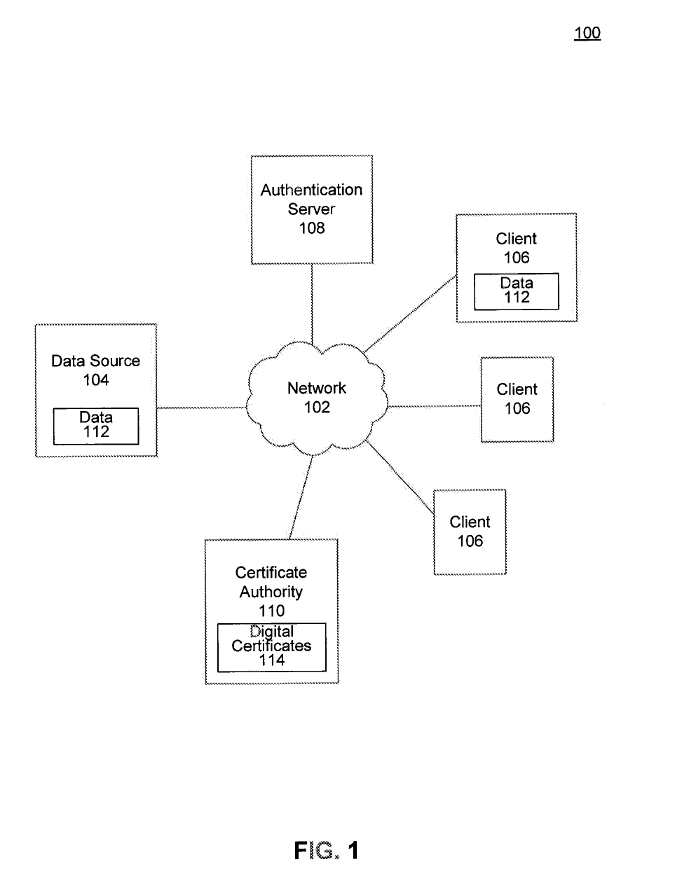

FIG. 1 is a block diagram of a distributed system 100. Distributed system 100 allows for secure data communication between multiple data sources 104 and clients 106. Distributed system 100 includes a network 102, data sources 104, clients 106, an authentication server 108 and a certificate authority 110.

Network 102 may be any network or combination of networks that can carry data communication. Such a network 102 may include, but is not limited to, a local area network, metropolitan area network, and/or wide area network such as the Internet. Network 102 can support protocols and technologies including, but not limited to, World Wide Web protocols and/or services. Intermediate web servers, gateways, or other servers may be provided between components of the system shown in FIG. 1 depending upon a particular application or environment.

Data source 104 is an electronic device, such as a server or another device capable of storing and disseminating data 112. Example data sources 104 may be databases, web servers, e-mail servers, cloud-based storages, to name only a few. Typically, data source 104 uses network 102 to disseminate data 112 to computing devices, such as clients 106. Clients 106 update, delete and modify data 112 and return data 112 to data source 104.

Data 112 is any data stored on data source 104. Example data 112 may be any digitized content, such as collections of numbers, personal accounts, images, documents, etc.

Client 106 is an electronic device that is under the control of a user and is capable of requesting and receiving data 112 over network 102. Example clients 106 include personal computers, mobile communication devices, (e.g. smartphones, tablet computing devices, notebooks), set-top boxes, and other devices that can send and receive data over the network 102.

Authentication server 108 controls the flow of data 112 between data sources 104 and clients 106. When client 106 requests data 112 from data source 104, client 106 accesses authentication server 108 for authentication. Once authentication server 108 authenticates client 106, client 106 is able to access data 112 on data source 104.

Authentication server 108 may perform authentication using cryptography, such as public key infrastructure (PKI). A person skilled in the art will appreciate that PKI authentication includes a digital certificate, such as digital certificate 114, and a public-private key pair, that includes a public key and a private key.

Certificate authority 110 is a trusted third-party entity that issues digital certificates 114. Digital certificate 114 includes an identity of the owner of digital certificate 114 and is bound to a public key. By issuing digital certificate 114, certificate authority 110 validates that the public key bound to digital certificate 114 belongs to an owner, such as a person, organization, server or another entity that is noted on digital certificate 114.

### 2. Generating an Encrypted Certificate Blob

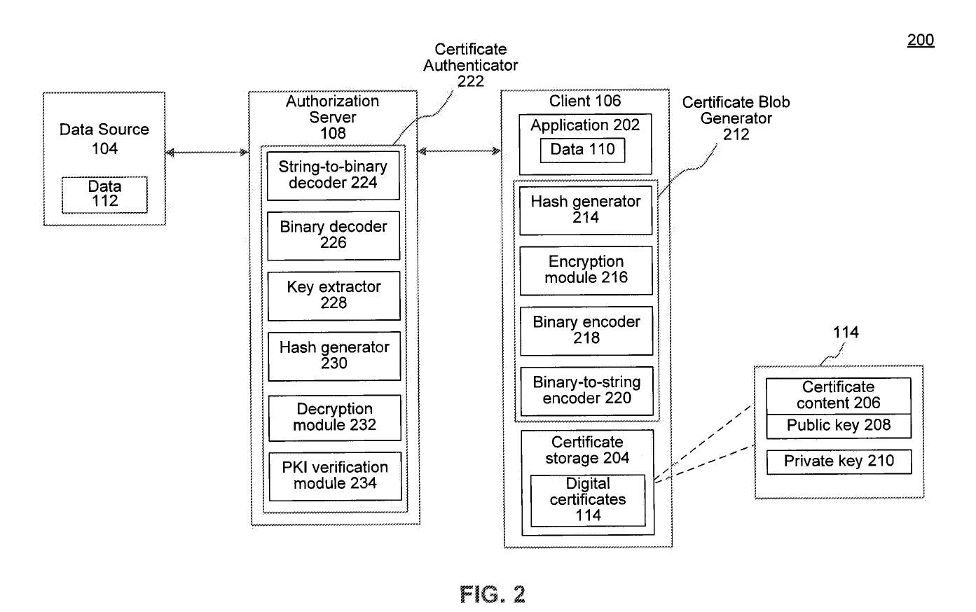

FIG. 2 is a block diagram of a certificate authentication system 200, according to an embodiment. Certificate authentication system 200 includes data source 104, authentication server 108 and client 106.

In an embodiment, client 106 includes an application 202 that exchanges data 112 with data source 104. Application 202 is any application that executes on client 106 and accesses data over network 102.

In an embodiment, application 202 receives data 112 from data source 104 by authenticating itself with authentication server 108. For example, each time application 202 needs to send or retrieve data from data source 104, application 202 authenticates itself with authentication server 108. In another embodiment, authentication server 108 decrypts the authentication information provided by application 202 and passes the authentication information to data source 104, that determines whether the authentication information is valid. If the authentication is successful, application 202 may use authentication server 108 to communicate with data source 104.

When a user downloads, installs or activates application 202 on client 106, the entity that owns application 202 provides a user with an associated digital certificate 114. Alternatively, the entity may cause certificate authority 110 to issue digital certificate 114 to the user. A user may be provided with digital certificate 114 by email, a compact disk, a thumb drive, network 102, or other means known to a person of ordinary skill in the art.

Once received by a user on client 106, client 106 may store digital certificate 114 in certificate storage 204. Certificate storage 204 is a memory storage on client 106 that stores digital certificates 114 for different mobile applications 202. In an embodiment, certificate storage 204 is encrypted or secure memory storage.

Digital certificate 114 includes digital certificate content 206. Digital certificate content 206 is a block of data that may include credentials of the owner of digital certificate 114, such as, for example, the entity that owns or licenses application 202. Digital certificate 114 is also bound to a public key 208. Public key 208 is an asymmetric key in the public-private key pair that authentication server 108 uses to authenticate client 106. A private key 210 from the public-private key pair is also provided to a user. Private key 210 is an asymmetric key in the private-public key pair that is known to client 106.

When a user receives digital certificate 114 from certificate authority 110, user also receives a password to unlock private key 210. A person skilled in the art will appreciate that certification authority 210 provides the password that unlocks private key 210 to the user separately from digital certificate 114.

Certificate blob generator 212 creates a certificate blob that authenticates client 106 to data source 104. In an embodiment, the authentication process occurs each time client 106 requests access to data source 104. Certificate blob generator 212 includes a hash generator 214, an encryption module 216, a binary encoder 218 and a binary-to-string encoder 220.

Hash generator 214 receives digital certificate 114 as input and creates a hash of certificate content 206. Hash generator 214 uses a hash function to create a hash of certificate content 206. Example hash functions are MD4, MD5, SHA-1 and SHA-2, to name only a few. A person skilled in the art will appreciate that hash generator 214 takes a block of data of variable length and uses a hash function to create a hash value in a form of a cryptographic, fixed-size bit string. A person skilled in the art will further appreciate that a change to certificate content 206 will change the hash value.

Encryption module 216 encrypts the hash of certificate content 206. For example, encryption module 216 receives the hash of certificate content 206 and encrypts it with private key 210 associated with digital certificate 114. Encryption module 216 produces an encrypted hash as an output that an authentication server 108 matches to an encrypted hash generated with public key 208 (as described below.)

Binary encoder 218 converts the encrypted hash and certificate content 206 into a binary format. A person skilled in the art will appreciate that an encoder is a device, circuit, transducer, software program, or an algorithm that converts data from one format or code to another, for the purposes of standardization, speed, secrecy, security, or saving space by shrinking size. Binary encoder 218 converts data into a format that includes binary numbers, such as “zeros” and “ones.” In an embodiment, binary encoder 218 uses Abstract Syntax Notation One (ASN.1) encoding algorithm, which is known to a person skilled in the relevant art, although the invention is not limited to this example.

Binary-to-String encoder 220 converts the output of binary encoder 218 into a certificate blob. Binary-to-String encoder 220 receives a binary representation of an encrypted hash and certificate contents 206 created by binary encoder 218 and converts them into a text string, such as an ASCII text string. A person skilled in the art will appreciate that an ASCII text standard uses 128 unique values (0-127) to represent the alphabetic, numeric, and punctuation characters commonly used in English, plus a selection of control codes which do not represent printable characters. In an embodiment, binary-to-string encoder 220 converts a binary of an encrypted hash and certificate contents 206 to a certificate blob using base64 encoding algorithm, also known to a person skilled in the relevant art.

The certificate blob created by binary-to-string encoder 220 is saved as an access password on client 106. In an embodiment, when client 106 accesses authentication server 108 to retrieve data 112 from data source 104, client 106 sends a message to authentication server 108 that includes certificate blob for authentication. If authentication server 108 authenticates the certificate blob, it allows client 106 to gain access to data 112 on data source 104.

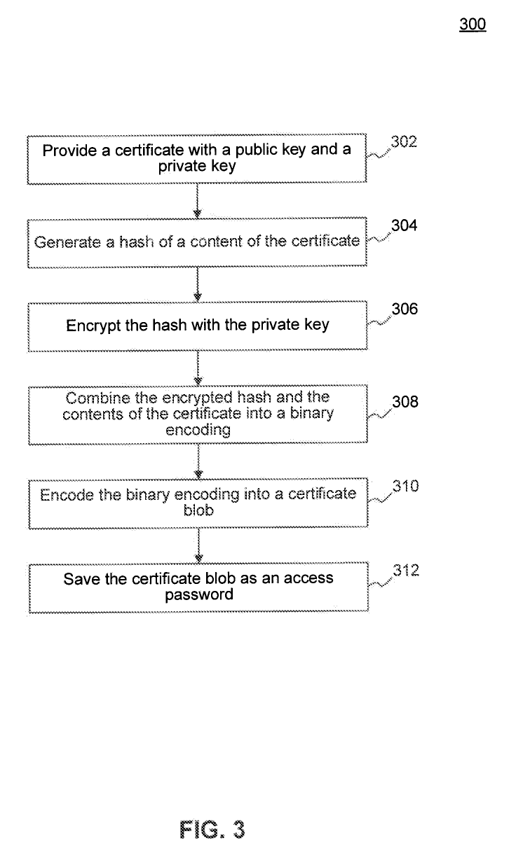

FIG. 3 is a flowchart 300 of a method for creating a certificate blob on a client, according to an embodiment.

At step 302, a digital certificate with a public key, and a private key is provided to a user. For example, once a user installs application 202 on client 106, a user may be provided with digital certificate 114 and a password to access private key 210, as described herein. As described herein, digital certificate 114 is bound to public key 208 and includes certificate content 206 that includes credentials of the owner of the certificate.

At step 304, a hash of certificate content is generated. For example, hash generator 214 uses a hash function to create a hash of certificate content 206, as described herein.

At step 306, the hash generated in step 304 is encrypted. For example, encryption module 216 encrypts the hash of certificate content 206 with a private key 210, as described herein.

At step 308, the encrypted hash and certificate content are converted into binary format. For example, binary encoder 218 converts the encrypted hash generated in step 306 and certificate content 206 into binary format, as described herein.

At step 310, a certificate blob is created. For example, binary-to-string encoder 220 converts the binary encoding generated in step 308 into a certificate blob, as described herein.

At step 312, a certificate blob is saved as an access password. For example, certificate blob created by binary-to-string encoder 220 is saved as an access password on client 106. As described herein, when client 106 accesses authentication server 108 to retrieve data 112 from data source 104 for application 202, client 106 sends a message to authentication server 108 that includes the certificate blob for authentication.

### 3. Decrypting the Certificate Blob

Going back to FIG. 2, when authentication server 108 receives a certificate blob, authentication server 108 decrypts the certificate blob. In one embodiment, authentication server 108 may authenticate client 106 to data source 104 with public key 208 and digital certificate 114 decrypted from the certificate blob. In another embodiment, authentication server 108 decrypts digital certificate 114 and sends the decrypted digital certificate 114 to data source 104 for authentication.

Authentication server 108 includes a certificate authenticator 222. Certificate authenticator 222 decrypts the certificate blob and authenticates digital certificate 114. Certificate authenticator 222 includes a string-to-binary decoder 224, a binary decoder 226, a key extractor 228, a hash generator 230, an encryption module 232 and a PKI verification module 234.

String-to-binary decoder 224 decodes the certificate blob. String-to-binary decoder 224 receives a certificate blob, in a string format as described herein, and decodes it into a binary representation. A person skilled in the art will appreciate that a decoder is a device which performs operations that are the reverse of an encoder in order to retrieve the original information that was encoded. String-to-binary decoder 224, therefore, decodes the certificate blob into a binary encoding that includes an encrypted hash and certificate content 206. In an embodiment, string-to-binary decoder 224 uses base64 decoding algorithm.

Binary decoder 226 decodes the binary encoding generated by string-to-binary decoder 224. Binary decoder 226 receives the binary encoding that includes an encrypted hash generated using a private key on client 106 and certificate content 206. Binary decoder 226 generates an encrypted hash and certificate content 206. In an embodiment, binary decoder 226 uses an Abstract Syntax Notation One (ASN.1) decoding algorithm.

Key extractor 228 receives certificate content 206 decoded by binary decoder 226. Key extractor 228 retrieves public key 208 bound to certificate content 206.

Hash generator 230 receives certificate content 206 as input and uses a hash function to create a hash of certificate content 206. Typically, hash generator 230 uses the same hash function as hash generator 214 to create a hash of certificate content 206.

Decryption module 232 receives the encrypted hash retrieved using binary decoder 226 and public key 208 as input. Decryption module 232 uses public key 208 to decrypt the encrypted hash. Typically, decryption module 232 reverses the encryption process performed by encryption module 216 on client 106.

PKI verification module 234 determines whether private key of the public-private key pair was used to encrypt the hash. For example, PKI verification module 234 verifies whether the decrypted hash obtained by decryption module 232 and the hash generated in step 230 match. If PKI verification module 234 determines that the hashes match, the verification is successful and client 106 is able to access data 112 on data source 104. Otherwise, verification fails and client 106 may receive a verification failure message from authentication server 108.

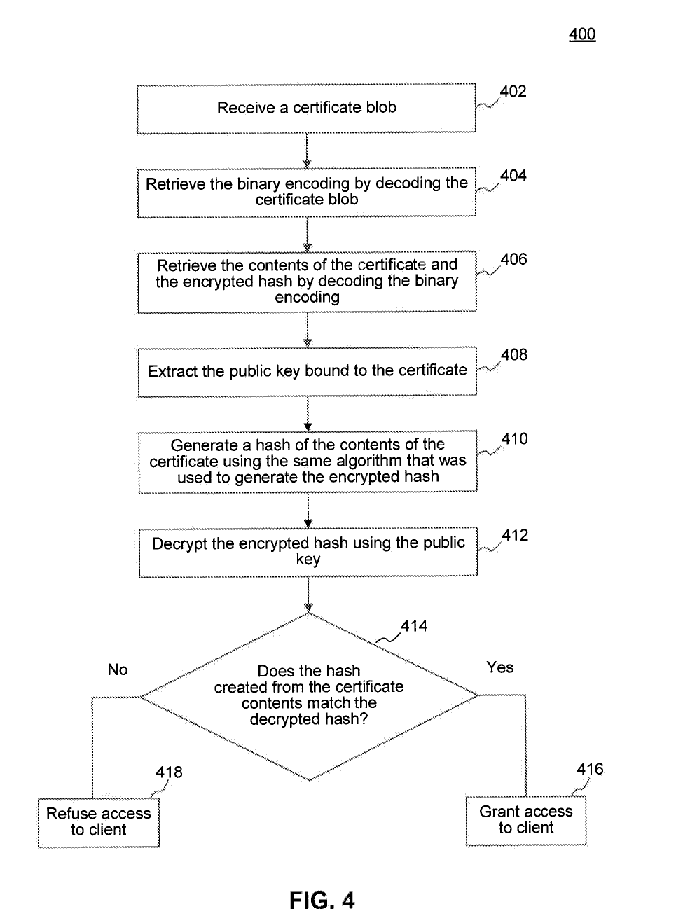

FIG. 4 is a flowchart 400 of a method for authenticating a certificate blob on a server, according to an embodiment.

At step 402, a certificate blob is received by an authentication server. For example, authentication server 108 receives a certificate blob from client 106.

At step 404, a certificate blob is decoded using a string-to-binary decoder. For example, string-to-binary decoder 224 receives a certificate blob and decodes it into a binary encoding that includes an encrypted hash and certificate content 206, as described herein.

At step 406, a binary encoding is decoded. For example, binary decoder 226 decodes the binary encoding generated by string-to-binary decoder 224. From the binary encoding, binary decoder 226 decodes an encrypted hash encoded in step 306 and certificate content 206, as described herein.

At step 408, a pubic key is extracted. For example, key extractor 228 retrieves public key 208 bound to certificate content 206 decoded in step 406.

At step 410, a hash of certificate contents is generated. For example, hash generator 230 receives certificate content 206 as input and uses a hash function to create a hash of certificate content 206, as described herein.

At step 412, a hash obtained in step 406 is decrypted. For example, decryption module 232 receives the encrypted hash obtained in step 406 and uses public key 208 to decrypt the encrypted hash, as described herein.

At step 414, the hash generated in step 410 and the hash decrypted in step 412 are compared. For example, PKI verification module 234 verifies that the hash decrypted using pubic key 208 and the hash generated using hash generator 230 match. If the hashes match, the authentication is successful and flowchart 400 proceeds to step 416, otherwise flowchart 400 proceeds to step 418.

At step 416, the verification of step 414 is successful. PKI verification module 234 verifies that the hashes match, and thus were produced by a public-private key pair. Application 202 executing on client 106 is, therefore, granted access to data sources 104. For example client 106 can send, retrieve and modify data 112 stored on data source 104.

At step 418, the verification of step 414 is unsuccessful. PKI verification module 234 verifies that the hashes were not produced by a public-private key pair. Because the verification was not successful, application client 106 is denied access to data 112 stored on data source 104.

### 4. Example Computer Implementation

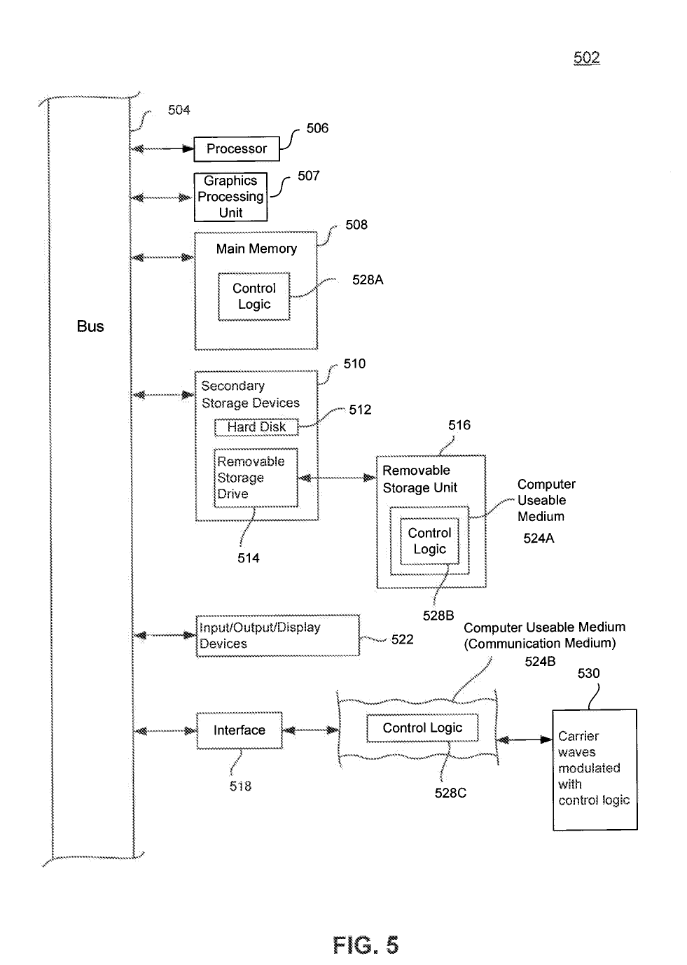

In an embodiment of the present invention, the system and components of the present invention described herein are implemented using well known computers, such as computer 500 shown in FIG. 5.

Computer 500 can be any commercially available and well known computer capable of performing the functions described herein, such as computers available from International Business Machines, Apple, Sun, HP, Dell, Compaq, Digital, Cray, etc.

Computer 500 includes one or more processors (also called central processing units, or CPUs), such as a processor 506. The processor 806 is connected to a communication bus 504. Processors 506 may include any conventional or special purpose processor, including, but not limited to, digital signal processor (DSP), field programmable gate array (FPGA), and application specific integrated circuit (ASIC).

Computer 500 includes one or more graphics processing units (also called GPUs), such as GPU 507. GPU 507 is a specialized processor that executes instructions and programs selected for complex graphics and mathematical operations in parallel.

The computer 502 also includes a main or primary memory 508, such as random access memory (RAM). The primary memory 508 has stored therein control logic 528A (computer software), and data.

The computer 502 also includes one or more secondary storage devices 510. The secondary storage devices 510 include, for example, a hard disk drive 512 and/or a removable storage device or drive 514, as well as other types of storage devices, such as memory cards and memory sticks. The removable storage drive 514 represents a floppy disk drive, a magnetic tape drive, a compact disk drive, an optical storage device, tape backup, etc.

The removable storage drive 514 interacts with a removable storage unit 516. The removable storage unit 516 includes a computer useable or readable storage medium 524 having stored therein computer software 528B (control logic) and/or data. Removable storage unit 516 represents a floppy disk, magnetic tape, compact disk, DVD, optical storage disk, or any other computer data storage device. The removable storage drive 1314 reads from and/or writes to the removable storage unit 516 in a well known manner.

The computer 502 also includes input/output/display devices 522, such as monitors, keyboards, pointing devices, touch-screen displays, etc.

The computer 502 further includes a communication or network interface 518. The network interface 518 enables the computer 502 to communicate with remote devices. For example, the network interface 518 allows the computer 502 to communicate over communication networks or mediums 524B (representing a form of a computer useable or readable medium), such as LANs, WANs, the Internet, etc. The network interface 1518 may interface with remote sites or networks via wired or wireless connections.

Control logic 528C may be transmitted to and from the computer 502 via the communication medium 524B. More particularly, the computer 502 may receive and transmit carrier waves (electromagnetic signals) modulated with control logic 530 via the communication medium 524B.

Any apparatus or manufacture comprising a computer useable or readable medium having control logic (software) stored therein is referred to herein as a computer program product or program storage device. This includes, but is not limited to, the computer 500, the main memory 508, the secondary storage devices 510, the removable storage unit 516 and the carrier waves modulated with control logic 530. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### 5. Conclusion

It is to be appreciated that the Detailed Description section, and not the Summary and Abstract sections, is intended to be used to interpret the claims. The Summary and Abstract sections may set forth one or more, but not all, exemplary embodiments of the invention as contemplated by the inventor(s), and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by the skilled artisan in light of the teachings and guidance.

The breadth and scope of the invention should not be limited by any of the above-described exemplary embodiments, but should be defined only in accordance with the following claims and their equivalents

What is claimed is:

1. A computer-implemented method for generating an authentication password for authenticating a client to a server, comprising:
accessing a digital certificate that includes a private key, and a public key;
generating a hash of a content of the digital certificate;
encrypting the hash with the private key;
encoding the encrypted hash and the content of the digital certificate into a certificate blob; and
utilizing the certificate blob as the authorization password.

2. The method of claim 1, wherein encoding includes a binary encoding of the encrypted hash and the content of the certificate.

3. The method of claim 2, wherein the binary encoding includes utilizing an ASN.1 encoding.

4. The method of claim 2, wherein the binary encoding includes utilizing a binary-to-string encoding.

5. The method of claim 4, wherein the binary-to-string encoding includes utilizing a base64 encoding.

6. The method of claim 1, further comprising:
sending the certificate blob to the server for authentication, prior to accessing data.

7. The method of claim 1, wherein the certificate blob authenticates a mobile device.

8. A system for generating an authentication password for authenticating a client to a server, comprising:
a hash generator configured to:
receive a digital certificate with a public key, and a public key; and
generate a hash of a content of the digital certificate;
an encryption module configured to encrypt the hash with the private key;
an encoder configured to encode the encrypted hash and the content of the certificate into a certificate blob; and
a storage configured to store the certificate blob as the authentication password.

9. The system of claim 8, wherein the encoder comprises a binary encoder, the binary encoder further configured to encode the encrypted hash and the content of the certificate with a binary encoding.

10. The system of claim 9, wherein the binary encoding utilizes an ASN.1 encoding.

11. The system of claim 9, further comprising a binary-to-string encoder further configured to encode the binary encoding into a text string.

12. The system of claim 11, wherein the binary-to-string encoding utilizes a base64 encoding.

13. The system of claim 8, further comprising a communication interface, the communication interface further configured to send the certificate blob to the server for authentication, prior to accessing data.

14. The system of claim 8, wherein the certificate blob authenticates a mobile device.

15. A computer-readable medium having instructions stored thereon, that when executed on a computing device, perform operations for generating an authentication password for authenticating a client to a server, comprising:
providing a digital certificate that includes a private key, and a public key;
generating a hash of a content of the digital certificate;
encrypting the hash with the private key;
encoding the encrypted hash and the content of the digital certificate into a certificate blob; and
utilizing the certificate blob as the authorization password.

16. The computer-readable medium of claim 15, wherein encoding includes a binary encoding of the encrypted hash and the content of the certificate.

17. The computer-readable medium of claim 16, wherein the binary encoding includes utilizing an ASN.1 encoding.

18. The computer-readable medium of claim 16, further comprising a binary-to-string encoder further configured to encode the binary encoding into a text string.

19. The computer-readable medium of claim 15, wherein the instructions that cause the computing device to perform operations for generating the authorization password, further comprise instructions to perform operations comprising:
sending the certificate blob to the server for authentication, prior to accessing data.

20. The computer-readable medium of claim 15, wherein the certificate blob authenticates a mobile device.
